(19) United States
(12) Patent Application Publication
(10) Pub. No.: US 2012/0166959 A1
(43) Pub. Date: Jun. 28, 2012

(54) SURFACING CONTENT INCLUDING CONTENT ACCESSED FROM JUMP LIST TASKS AND ITEMS

(75) Inventors: Israel Hilerio, Kenmore, WA (US); Alexander H. Malek, Seattle, WA (US); Bruce A. Morgan, Bellevue, WA (US); John E. Davis, Renton, WA (US); Justin Martin Posey, Redmond, WA (US); Kinnary M. Jangla, Bellevue, WA (US); Phu Hoang Le, Bellevue, WA (US); David J. Rubino, Bellevue, WA (US); Mara B. Patton, Seattle, WA (US)

(73) Assignee: MICROSOFT CORPORATION, Redmond, WA (US)

(21) Appl. No.: 12/977,668

(22) Filed: Dec. 23, 2010

(51) Int. Cl. G06F 3/01; G06F 15/16

(52) U.S. Cl. 715/738

(57) ABSTRACT

Various embodiments provide a mechanism to allow end users to install web applications and websites onto their desktop. In accordance with one or more embodiments, client-side code can be utilized to allow developers associated with a website to define boundaries associated with user interaction, and have those boundaries enforced by a run-time engine. In at least some embodiments, developers can provide, through JavaScript code and/or HTML markup, various configurations for the creation of a start menu shortcut, navigation, and so-called jumplist integration.

### BACKGROUND

More recently, industry has begun to focus on the notion of integrating web applications or websites with a user's computer desktop environment or “desktop”. There are, however, challenges associated with doing so. For example, today it is difficult for websites to define the boundaries of their sites for the purpose of desktop integration. Thus, end-users are left to define the boundaries through client-side script that they develop themselves. This can be problematic because an end-user may not necessarily know how a particular web site is constructed. For example, the end user may not necessarily know all of the links, relationships between web properties, or other nuances employed by a website to provide functionality to the user. Accordingly, the end-user's script may not appreciate these links or nuances and, hence, can lead to an undesirable or broken user experience.

In addition, users today face what is known as a dual boot problem. Specifically, users are forced to boot their personal computers, start their browsers, and finally launch a particular web application that they wish to work within. This problem is compounded by the fact that browsers can provide too many distractions for users, such as those that appear in a browser's chrome, and do not allow the users to simply concentrate on a particular task at hand associated with a web application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a mechanism to allow end users to install web applications and websites onto a client device, such as a client device desktop. In accordance with one or more embodiments, client-side code can be utilized to allow developers associated with a website to define boundaries associated with user interaction, and have those boundaries enforced by a run-time engine. In at least some embodiments, developers can provide, through JavaScript code, various configurations for the creation of a start menu shortcut, navigation, and so-called jumplist integration, as well as a number of other features.

Various embodiments enable a site developer to define how content is to be surfaced on a client device, including content that is accessed from a jumplist task or item. Content can be surfaced through a variety of content conveyances. For example, content can be surfaced using a tab, pop-up window, browser window, an in-place navigation, or at different levels, such as within a page, such as within a frame or other element. Further, content can be caused to be surfaced using different surfacing mechanisms such as those that employ declarative approaches such as markup like HTML markup and/or script-based approaches, such as through the use of Javascript.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates a web application window in accordance with one or more embodiments.

FIG. 3 illustrates a JavaScript API in accordance with one or more embodiments.

FIG. 4 is a flow diagram that describes steps in an installation method in accordance with one or more embodiments.

FIG. 5 is a flow diagram that describes steps in a web application interaction method in accordance with one or more embodiments.

FIG. 6 illustrates a portion of a client desktop in accordance with one or more embodiments.

FIG. 7 illustrates a JavaScript API in accordance with one or more embodiments.

FIG. 8 illustrates dynamic interaction between a website and a custom jumplist in accordance with one or more embodiments.

FIG. 9 illustrates a portion of a client desktop in accordance with one or more embodiments.

FIG. 10 illustrates a portion of a client desktop in accordance with one or more embodiments.

FIG. 11 is a flow diagram that describes steps in an installation method in accordance with one or more embodiments.

FIG. 12 is a flow diagram that describes steps of a method in accordance with one or more embodiments.

FIG. 13 is a flow diagram that describes steps in a method in accordance with one or more embodiments.

FIG. 14 illustrates a client desktop in accordance with one or more embodiments.

FIG. 15 diagrammatically illustrates a drag and a drop operation in accordance with one or more embodiments.

FIG. 16 is a flow diagram that describes steps in an installation method in accordance with one or more embodiments.

FIG. 17 illustrates a client desktop in accordance with one or more embodiments.

FIG. 18 is a flow diagram that describes steps in an installation method in accordance with one or more embodiments.

FIG. 19 illustrates a client desktop in accordance with one or more embodiments.

FIG. 20 is a flow diagram that describes steps in a method in accordance with one or more embodiments.

FIG. 21 a flow diagram that describes steps in a method in accordance with one or more embodiments.

FIG. 22 illustrates an example system that can be utilized to implement one or more embodiments.

### DETAILED DESCRIPTION

Overview

Various embodiments provide a mechanism to allow end users to install web applications and websites onto a client device, such as a client device desktop. In accordance with one or more embodiments, client-side code can be utilized to allow developers associated with a website to define boundaries associated with user interaction, and have those boundaries enforced by a run-time engine. In at least some embodiments, developers can provide, through JavaScript code, various configurations for the creation of a start menu shortcut, navigation, and so-called jumplist integration, as well as other features.

Various embodiments enable a site developer to define how content is to be surfaced on a client device, including content that is accessed from a jumplist task or item. Content can be surfaced through a variety of content conveyances. For example, content can be surfaced using a tab, pop-up window, browser window, an in-place navigation, or at different levels, such as within a page, such as within a frame or other element. Further, content can be caused to be surfaced using different surfacing mechanisms such as those that employ declarative approaches such as markup like HTML markup and/or script-based approaches, such as through the use of Javascript.

Boundaries can be thought of as a developer-defined experience that relates to how functionality is exposed to an end-user. Boundaries are associated with website domains, such as top-level domains and sub-domains that might be associated with separate applications, or a subset of websites that are hosted on a domain. Hence, the boundaries can be defined by a set of domains, sub-domains, folders, sub-sites, protocols, hosts, paths, and the like, that are utilized to make a particular web application work.

In one or more embodiments, websites can opt into the functionality described above and below. In this case, developers can provide code which, in some instances is expressed in JavaScript, which defines the boundaries of the user's experience with their website. Such can enable a site developer to define a number of different aspects of a user's experience such as, for example, how content is to be surfaced on a client device, including content that is accessed from a jumplist task or item. Alternately or additionally, websites that do not opt into the functionality described above and below can have a default experience provided for them.

In the discussion that follows, a section entitled “Operating Environment” is provided and describes one environment in which one or more embodiments can be employed. Following this, a section entitled “Integration Infrastructure” describes infrastructure that enables web applications to be integrated onto a client device in accordance with one or more embodiments. Next, a section entitled “Jumplist Integration” describes how so-called jumplists can be integrated in accordance with one or more embodiments. Next, a section entitled “Taskbar Pinning” describes how web applications can be pinned to a taskbar in accordance with one or more embodiments. Following this, a section entitled “Using Metatags to Define How Content is to be Surfaced” describes embodiments in which metatags are employed to define visual conveyances in which content can be surfaced in accordance with one or more embodiments. Following this, a section entitled “Using Script to Define How Content is to be Surfaced” describes how script can be employed to define visual conveyances in which content can be surfaced in accordance with one or more embodiments. Last, a section entitled “Example System” describes an example system that can be utilized to implement one or more embodiments.

Consider now an example operating environment in which one or more embodiments can be implemented.

Operating Environment

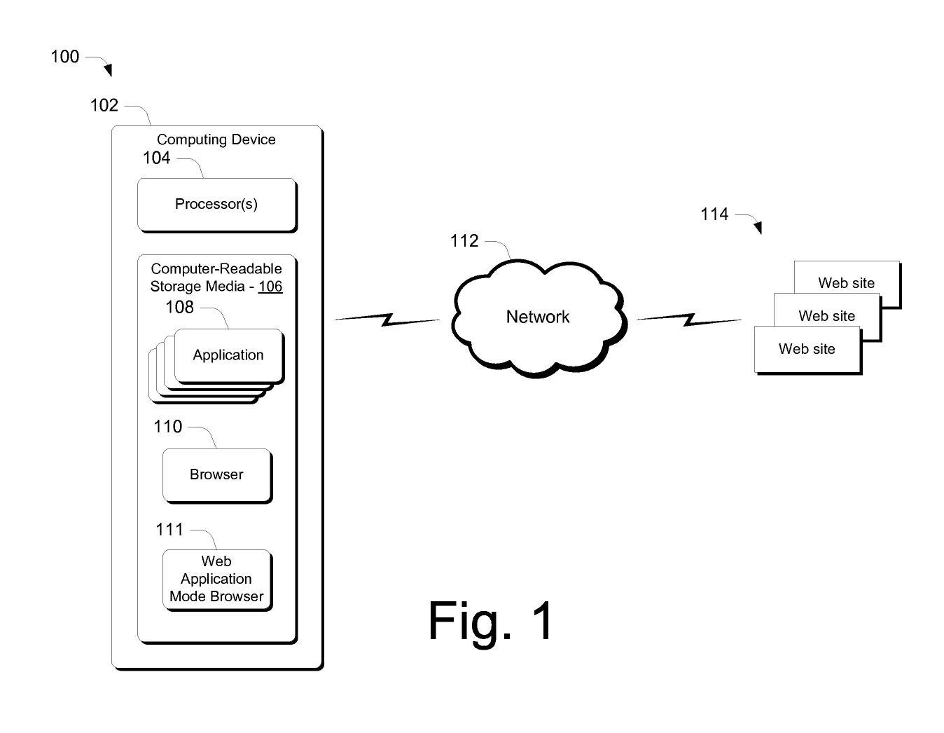

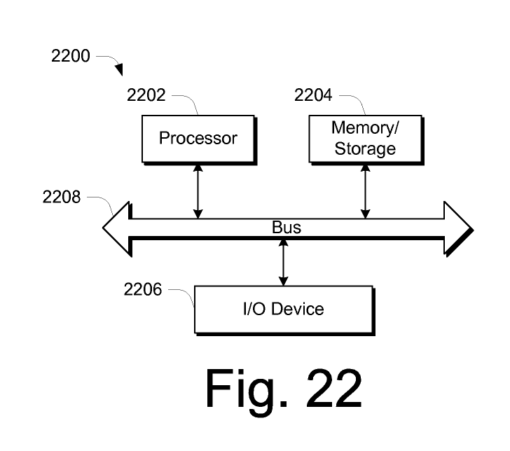

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 22.

In addition, computing device 102 includes a software application in the form of a web browser 110. Any suitable web browser can be used examples of which are available from the assignee of this document and others. In addition, computer-readable storage media 106 can include a web application mode browser 111 that operates as described above and below. The web application mode browser 111 serves as a runtime engine that receives and makes API calls from and to websites respectively, oversees web application installation processes, enforces boundaries, and enables functionality as described above and below. In operation, the web application mode browser is a pared down version of a full browser, with many of the normal browser functionalities turned off. In some instances, the web application mode browser can be thought of as a “chrome-less” browser that does not include many of the usual browser controls. Some commands may, however, be exposed through a miniature control bar. The web application mode browser thus removes many of the distractions for a user and permits a directed, website-defined user experience in which the websites can control how the user interacts with their web application.

In operation, the web application mode browser can be considered to reside logically between a website and the client device's operating system. Thus, the web application mode browser receives calls from websites and can, responsively, make operating system calls to affect the functionality described herein. Likewise, the web application mode browser can receive calls from the operating system, that will affect the functionality of the website. For example, the operating system exposes APIs that enable interaction with a desktop's task bar. The web application mode browser can receive calls from a website and, responsively, can make API calls that enable task bar functionality, as well as other functionality, as will become apparent below.

Web application mode browser 111 can be implemented as a standalone component. Alternately or additionally, the web application mode browser 111 can be implemented as part of applications 108 and/or browser 110.

In addition, environment 100 includes a network 112, such as the Internet, and one or more web sites 114 from and to which content can be received and sent. Such content can include content, such as web applications, that is integrated onto the client desktop or otherwise useable through the client device, as described above and below.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of infrastructure that allows web applications to be integrated onto a client device.

Integration Infrastructure

In accordance with one or more embodiments, websites can opt into domain navigation that is provided as part of a more general “site mode” experience. Domain navigation enables websites to customize the behavior of their existing websites when users access links inside and outside of specific domains. When accessing links inside developer-specified boundaries, content can be rendered and consumed within a web application window, or some other conveyance, such as those defined by a site or developer, that is rendered by the web application mode browser as part of an associated web application. When accessing links outside of the developer-specified boundaries, associated content can be rendered and consumed inside of a default browser that is outside of the web application mode browser. This allows a website to define what domains should be treated as an extension of the website, and which should not.

In one or more embodiments, navigation domains can be defined by web developers and identify links whose content is displayed by the web application mode browser as part of the integrated website, or outside of the web application mode browser in the default browser. In addition, default domain parameters can be defined that are used to associate a collection of web application pages together.

As an example, consider the following in-line domain page definition:

This domain page definition will allow URIs of the form just below to be displayed in the same desktop web application window:

sales.contoso.crm.dynamics.com\*

hr.contoso.crm.dynamics\*

*.microsoft.com\crm\

Likewise, this domain page definition will force other URIs to be displayed outside of the desktop web application window, even if the link references are inside a page within the desktop web application window:

www.bing.com

home.live.com

In the above domain page definition, wild cards are utilized inside the web application installation API. This API is typically called by the website when the user selects a website integration link provided by the website. This API can populate a web application file or “.website” file with information and content in the desktop, task bar, or start menu, or any other suitable location that will be used to launch a website shortcut. It is to be appreciated and understood that any suitable file extension can be used to designate a web application file. The navigation domains and other boundary information are stored within the .website file.

When the .website file is launched, navigation domains therewithin are enforced by the web application mode browser 111. Links selected by the user or accessed by the website continue to execute inside the web application window as long as they match the wildcard domains. However, when a website is detected that is outside of the defined navigation domains, a default browser is instantiated or otherwise used, and content associated with the website is displayed outside of the web application window and inside the default browser.

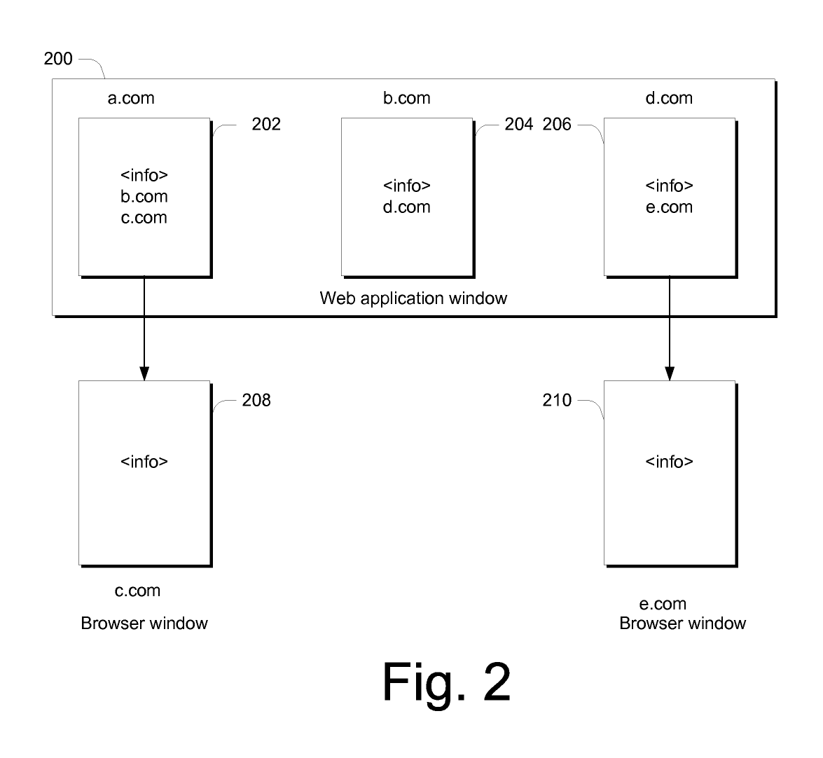

As an example, consider FIG. 2, which illustrates a web application window 200 having a navigation domain set of a.com (202), b.com (204) and d.com (206), which implies that all pages from these domains are displayed inside the web application window 200. When pages from c.com (208) or e.com (210) are accessed from within the web application window 200, they are displayed in the default browser window and not in the web application window 200.

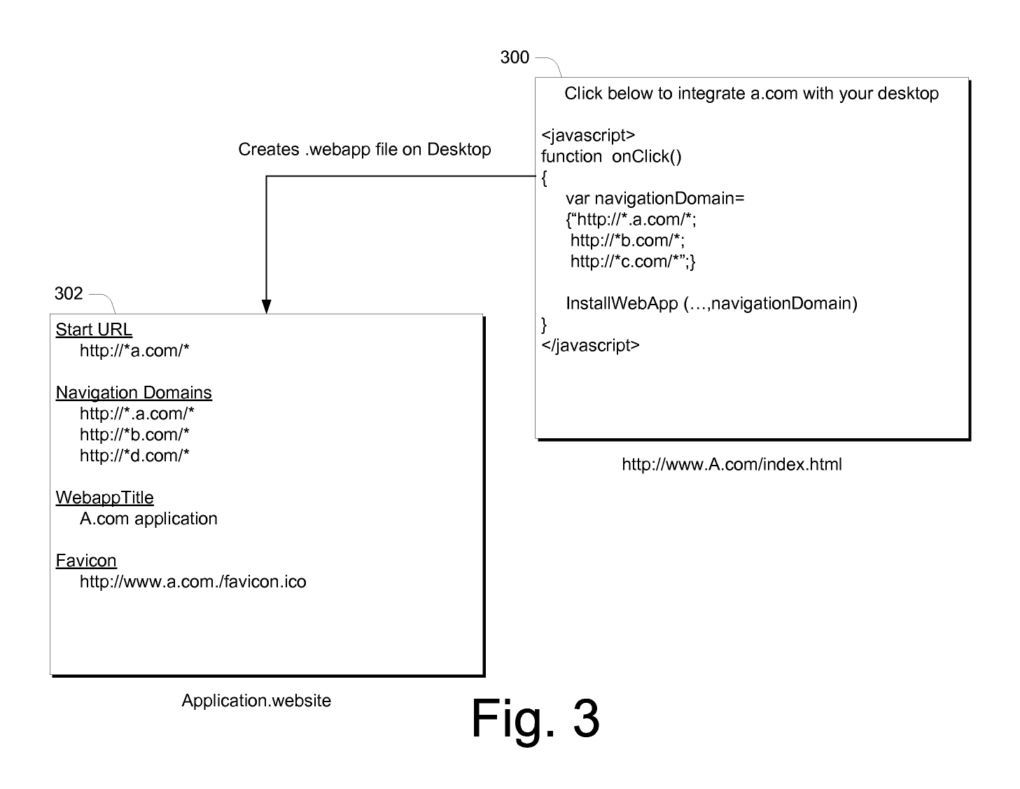

FIG. 3 illustrates a JavaScript API in accordance with one or more embodiments at 300. The illustrated JavaScript API enables a website to integrate a web application with a client desktop. The API defines the navigation domains that will be enforced by the web application or run-time engine. In this example, the navigation domains are described using wild-card expressions as illustrated above. This API enables population or updating of a .website application file 302 with content and information on the client device and stores the navigation domains and other information in it. These navigation domains are enforced when the web application is launched.

In the illustrated and described embodiment, .website application file 302 includes information that the website has defined for its site mode configuration. This information includes a start URL which is the initial page that is displayed by the web application mode browser, all of the navigation domains that the website has specified, a web application title, and a so-called favicon. Other information can be included, as will be described below.

Now, once the web application is launched on client side, the web application mode browser reads the web application file and enforces the boundaries defined therein. As noted above, because the web application experience is defined by developers who are knowledgeable of a particular website and its nuances, a complete and integrated user experience can be provided.

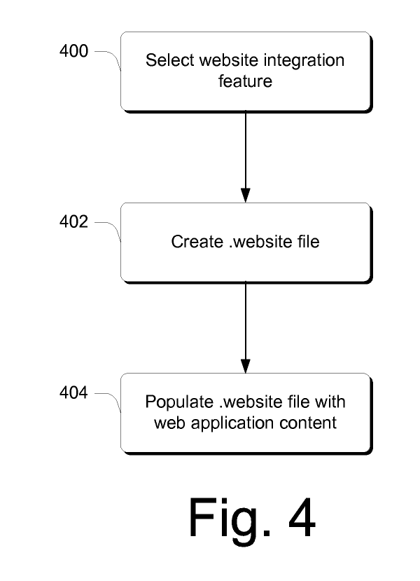

FIG. 4 is a flow diagram that describes steps in an installation method in accordance with one or more embodiments. The method can be performed by any suitable hardware, software, firmware, or combination thereof. In at least some embodiments, aspects of the method are performed by software executing on a client device.

Step 400 selects a website integration feature. The step can be performed in any suitable way. Typically, the step is performed when a user selects an instrumentality or otherwise takes an action to initiate a web application installation process. For example, a user might select a link that enables him to integrate the web application. Specific examples of how this can be done are provided below.

Step 402 creates, on the client device, a web application file—here designated “.website” file. This file, as initially created, can constitute an artifact or shell that can subsequently be populated with content and information received from or on behalf of the website. Step 404 populates the web application file with web application content. This step can be performed in any suitable way. For example, this step can be performed through the use of a JavaScript API examples of which are provided above and below. Alternately or additionally, this step can be performed through the use of markup, such as HTML.

Having created the web application file on the client and populated it with content, the web application can now be launched and interacted with.

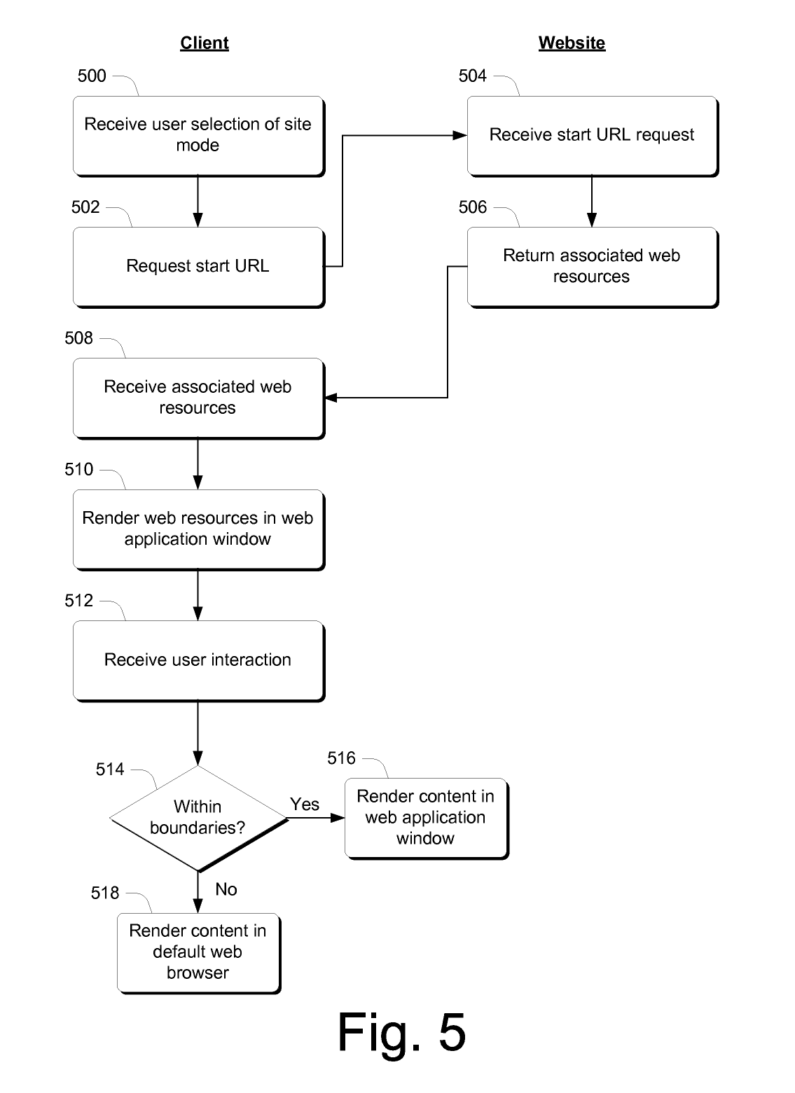

FIG. 5 is a flow diagram that describes steps in a web application interaction method in accordance with one or more embodiments. The method can be performed by any suitable hardware, software, firmware, or combination thereof. In at least some embodiments, aspects of the method are performed by software executing on a client, and software executing at a server supporting a website. Accordingly, one column of the diagram is designated “Client” to designate those steps performed by or at the client by, for example, a web application mode browser, and one column is designated “Website” to designate those steps performed by or on behalf of the website.

Step 500 receives a user selection of a site mode. This step can be performed in any suitable way. For example, a shortcut installed on the client desktop can be utilized to receive a site mode selection. Responsive to receiving the site mode selection, step 502 requests a start URL. The start URL can be found in the web application file described above.

Step 504 receives the start URL request. Step 506 returns associated web resources, including content associated with the start URL, to the client.

Step 508 receives the associated web resources and step 510 renders the web resources in a web application window. As described above, the web application window is rendered by the web application mode browser. In some embodiments, the web application mode browser runtime configuration is at least partially defined by contents of the web application file. In one or more other embodiments, the runtime configuration can be defined, at least partially, by data that is maintained in other locations, such as a local cache or caches, as will become apparent below. Step 512 receives a user interaction with respect to the resources rendered in the web application window. The user interaction can include any suitable type of user interaction. For example, the user interaction may include a navigation activity that originates from within the web application window. Step 514 ascertains whether the user interaction is within the boundaries defined by the web application file. If the user interaction is within the boundaries defined by the web application file, step 516 renders content associated with the user interaction in the web application window. If, on the other hand, the user interaction is not within the boundaries defined by the web application file, step 518 renders content associated with the user interaction in a default web browser.

In this manner, boundaries defined by website developers for particular websites can be enforced to ensure that the user experience is preserved as desired by the developers. For example, the website defined Start URL is the home page, and subsequent access to the home page in web application mode navigates to the Start URL, rather than the user's originally defined browser home page. This allows for quick access to the web application specific page, instead of some unrelated home page. This alleviates end-users from having to define their own site-specific experiences which may or may not work accurately. As such, a complete, integrated, and intelligently-managed experience can be provided for end-users.

Having described an example installation and interaction experience, consider now the notion of jumplist integration.

Jumplist Integration

In one or more embodiments, developers can enable websites to define a series of so-called jumplist tasks during desktop integration that can be used to interact with the websites. In addition, in at least some embodiments websites can create and update custom jumplists.

A jumplist can be thought of as a list that constitutes a set of relevant tasks or content that is presented to the user. Through jumplists, websites can promote a distillation of relevant and useful information to users. Jumplists are related to the capabilities or functionalities of a particular web application. For example, a jumplist for an e-mail application might include tasks that give the user the ability to open a contact, create a new e-mail message, and the like. In some instances, jumplists can include a list of relevant and most-often used commands and data.

In one or more embodiments, jumplist functionality can be implemented to include both static elements and dynamic elements.

Developers can define the static elements during the web application installation process that populates the web application file, as described above. Settings associated with the static elements can be stored inside the web application file. In one or more embodiments, the settings can include a list name and associated tasks. In at least some instances, the static elements can constitute elements that represent commonly-used functionality.

Settings associated with the dynamic elements can be driven by website pages that run inside the web application window. These settings include settings that dynamically expose discernible indicia for a user. For example, one setting can add an item to a custom jumplist, and one setting can display an overlay icon, examples of which are provided below. In at least some embodiments, dynamic settings can be cleared each time the web application is launched and can be configured by web application script code.

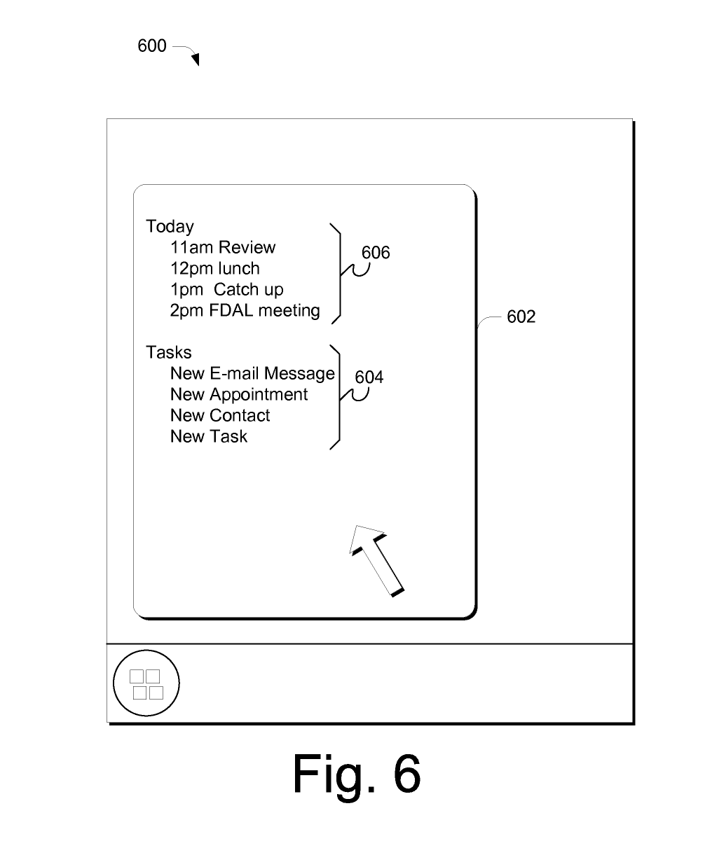

As an example of a custom jumplist in accordance with one embodiment, consider FIG. 6, which illustrates a portion of a client desktop generally at 600. A custom jumplist 602 is exposed in accordance with one or more embodiments. Here, static elements are illustrated at 604 and dynamic elements are illustrated at 606. In this example, the static elements list name is “Tasks” and the tasks or static elements include “New E-mail Message”, “New Appointment”, “New Contact”, and “New Task”. The dynamic elements list name is “Today” and the tasks or dynamic elements include, in this example, reminders that are generated from a user's calendar. The dynamic elements are dynamically populated by an associated website. So, in this example, the dynamic elements or content are associated with providing notifications to the user, typically independent of a user's action.

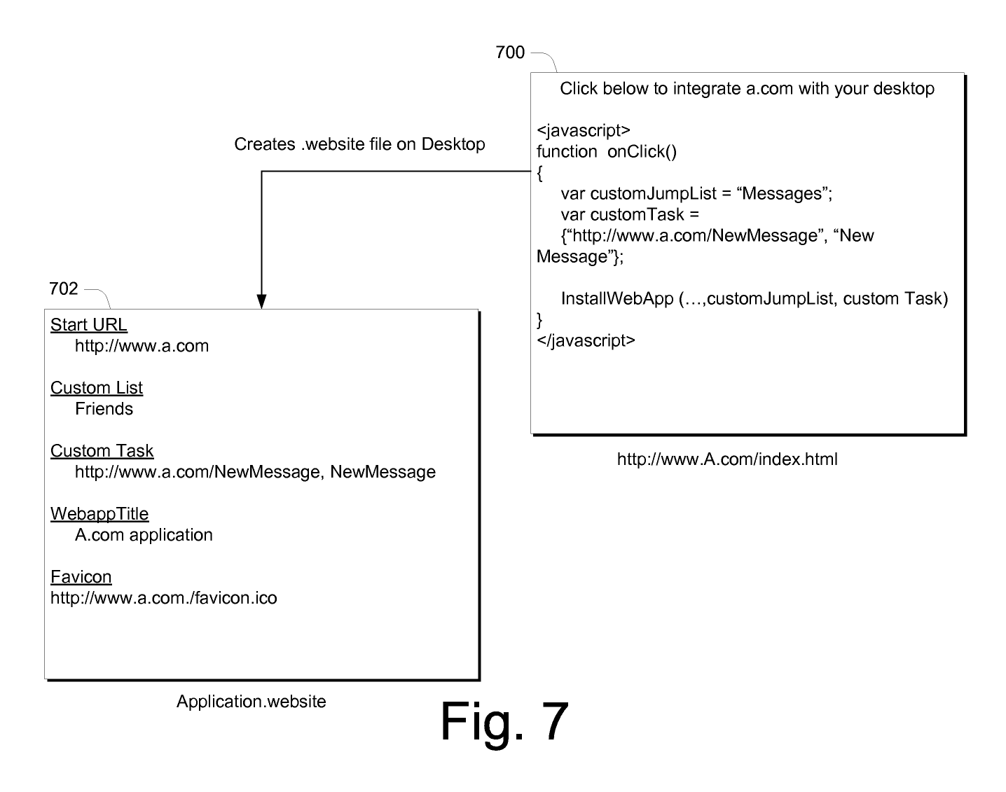

As noted above, jumplists can be defined during the desktop integration process. The tasks and the jumplist definition can be stored inside the web application file. As an example, consider FIG. 7 which illustrates a JavaScript API in accordance with one or more embodiments at 700. The illustrated JavaScript API enables a website to integrate with a client desktop and to define a jumplist. This JavaScript API can be the same as or similar to the one described with respect to FIG. 3, except for the presence of “custom task” and “customJumpList.” For brevity, some of the FIG. 3 content has been omitted. In at least some embodiments, initial creation of a static list of jumplist tasks can be defined by markup, e.g. using HTML tags, that are defined inside an HTML document.

For example, consider the example just below that uses metatags to describe the static list functionality:

<META name=″msapplication-task″
content=″name=Task;uri=http://marap/test3.html;icon-
uri=http://marap/icon3.ico″/>

When a task is executed, in one or more embodiments, there are a couple options. For example, the URL associated with the task can be opened inside the same web application/browser window that contains the currently viewed webpage. Alternately or additionally, a new page can be launched. Alternately or additionally, a new pop-up window can be displayed.

After these parameters are defined and read by the system, they can be used when the user installs the web site on their desktop, as by adding it to the Start Menu or pinning it to the task bar as described below. At the same time, in at least some embodiments, there is a set of dynamic values that can be manipulated by website client code on the jumplist.

“Custom task” is utilized by the website to define static tasks as described above. In this example, the static task is a new message static task. This API creates a .website application file 702 on the desktop and stores the navigation domains (as in the FIG. 3 example) and other information, such as information associated with jumplists.

In the illustrated and described embodiment, .website application file 702 includes information that the website has defined for its site mode configuration. This information includes a start URL, all of the navigation domains that the website has specified (not specifically illustrated), a web application title, and a so-called favicon. Other information includes the custom task associated with a new message mentioned above, and a “custom list”. In this example, the custom list element is a dynamic element that can be dynamically populated by the website when the web application is running on the client. Here, the “friends” designation comprises a header that is associated with dynamic content. So, in this instance, the dynamic content is associated with providing notifications to the user when their friends are online. Here, the custom list is a separate API that does not reside in the web application. The custom task, however, resides in the web application.

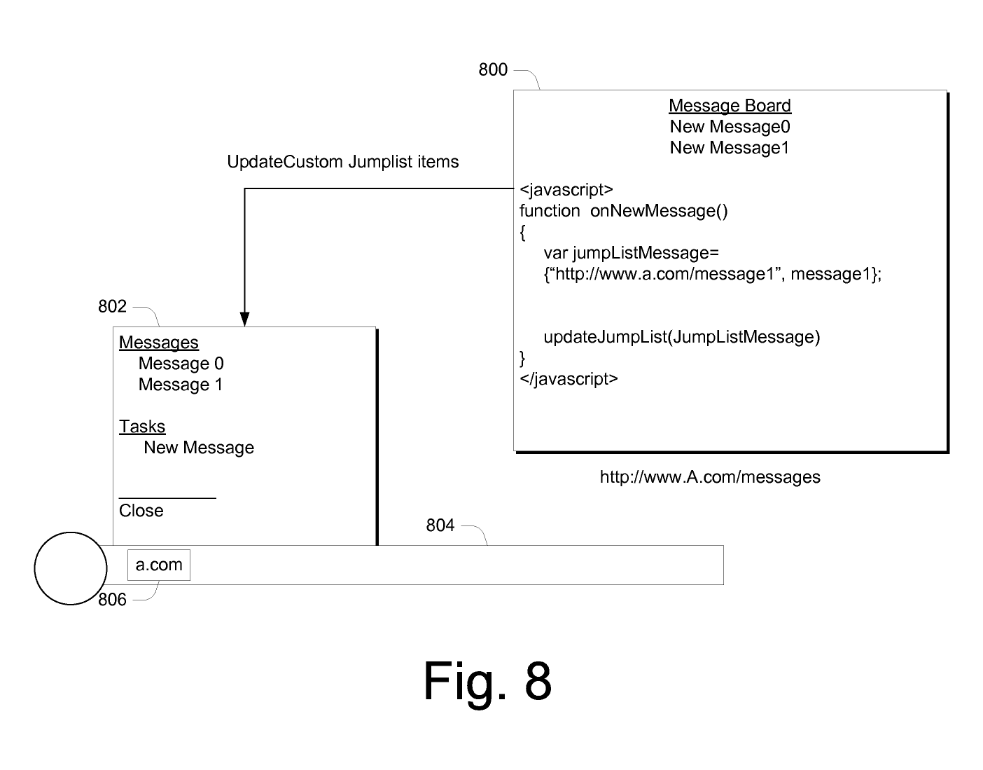

In operation, items associated with static elements can be pre-fetched and cached for when a web application is running. Items associated with dynamic elements, on the other hand, can be provided by a website on-the-fly when the web application is running. As an implementation example of how items associated with the dynamic elements can be provided to the web application on-the-fly, consider FIG. 8.

FIG. 8 illustrates how a website is able to dynamically interact with the custom jumplist to allow the user to know that a message has arrived. In this example, JavaScript 800 illustrates how a website can send updates to a page that is hosted in the web application mode browser. Client-side code that is executed in the browser is responsible for receiving updates, updating the content on screen, and sending a request to the jumplist to update its list. In this example, the website is able to push information to the jumplist to provide a real time experience. Here, when a new message is received by the website, e.g. New Message0 and New Message1, a JavaScript call can be made from the web application to update jumplist 802. In at least some embodiments, a notification can appear in task bar 804 to inform the user that relevant information has been received. Notification can appear in any suitable location in the task bar and can comprise any suitable type of notification. For example, the notification can appear in or around icon 806 that is associated with the web application. Alternately or additionally, the notification can flash so as to catch the user's eye.

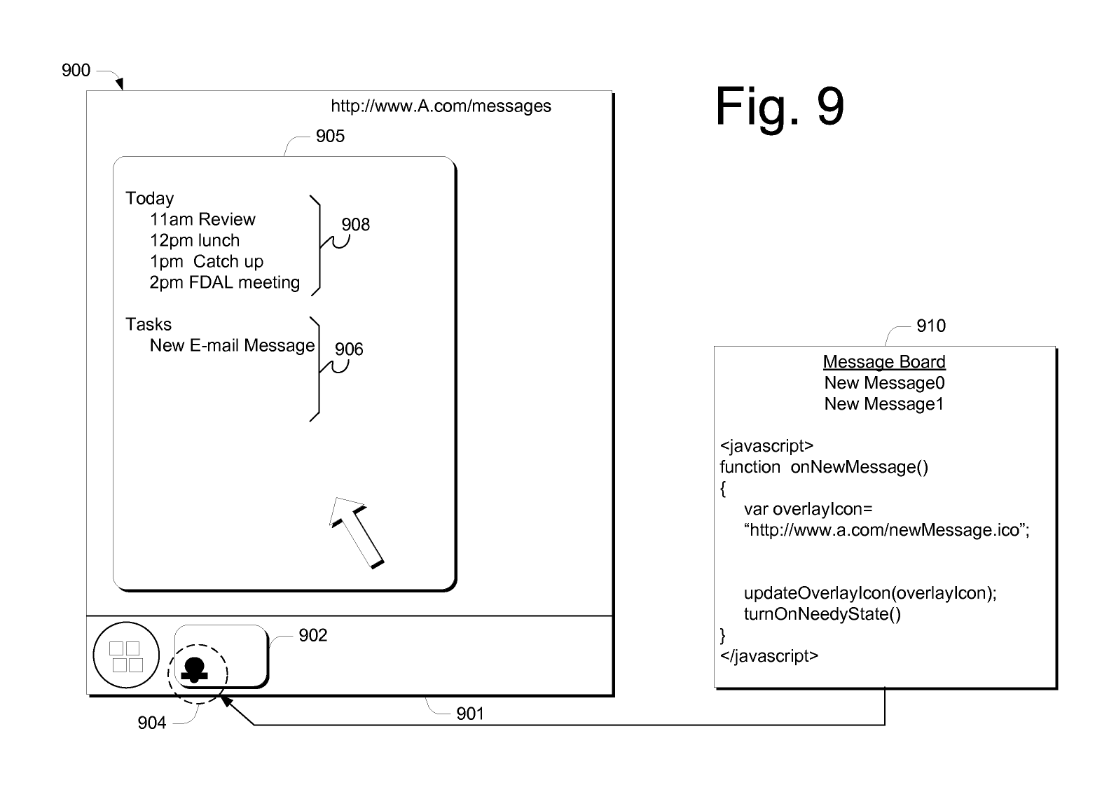

As an example, consider FIG. 9. There, a portion of a client desktop is illustrated generally at 900. A task bar 901 includes an icon 902 associated with a current web application. Notice here, that an overlay icon 904 has been rendered within icon 902. In this example, a user has received a new message, and the website has called into the web application, as described above, to cause overly icon 904 to be rendered within icon 902. This provides notification to the user that a new message has arrived. Responsive to seeing the overly icon 904, the user can access jumplist 905 to expose elements 908 which indicates an appointment that is currently happening or about to happen. Notice also that elements 906 are exposed as well. JavaScript excerpt 910 illustrates one example of code that can be used to update the overlay icon.

Dynamic interaction between the website and a web application can occur in various other ways. For example, in at least some embodiments a preview window can be pushed from the website to the jumplist responsive to a user's action with respect to the web site. In the illustrated and described embodiment, the preview window is a miniature view provided by the web site. The preview window can be provided responsive to any suitable type of user action. For example, in at least some embodiments, a preview window can be pushed from the website to the jumplist responsive to a mouse hover over a task bar icon associated with the web site. Alternately or additionally, a preview window can be provided by placing a cursor over the web application's task bar icon and left clicking

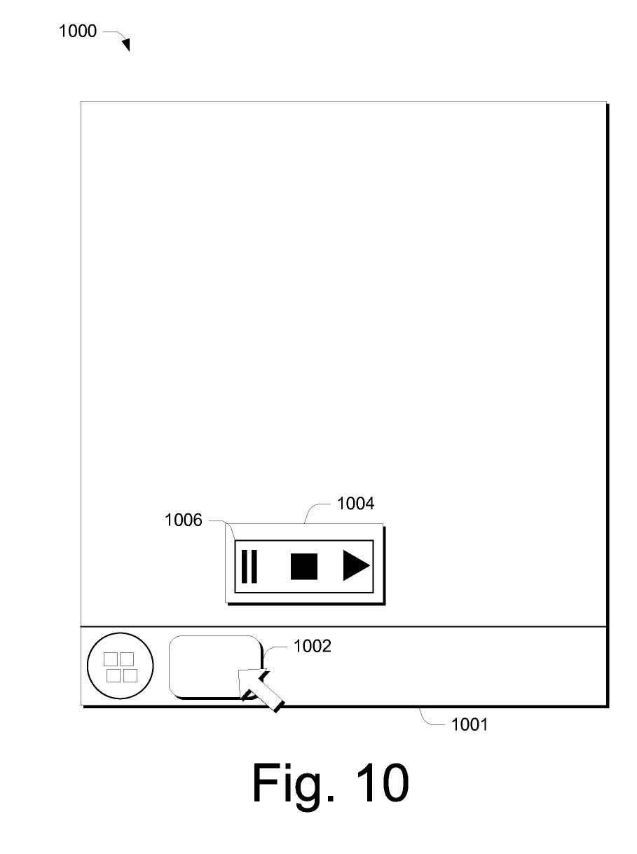

As an example, consider FIG. 10. There, a portion of a client desktop is illustrated generally at 1000. A task bar 1001 includes an icon 1002 associated with a current web application. Notice here, that the user has placed their cursor over icon 1002. Responsively, a preview window 1004 has been rendered. In operation, responsive to the user's action of placing their cursor over the icon, an event is transmitted to the web page. Responsive to receiving the event, the web page can then dynamically provide the preview, or cause a cached preview window to be rendered.

In at least some embodiments, the preview window can also be used by the website to define toolbar buttons and associated behaviors. For example, in the illustrated and described embodiment, the web application comprises a media player application and three toolbar buttons appear in a user interface instrumentality 1006 that is overlaid over preview window 1004. The buttons include a pause button, a stop button, and a play button. In at least some embodiments, the toolbar buttons can be implemented using client-side code that avoids having to interact with a remote server. For example, individual buttons can be registered for a particular web page. Each button is configured and assigned an ID. One “listener” is registered for all button events. When a button is pressed, an event is generated and communicated back to the browser which then propagates the event to the registered event listener. The event contains the button that was pressed. This enables disambiguation between buttons.

Implementation Example

In an implementation example, web developers can use the following JavaScript functions to update a custom list in the jumplist, and to update the task bar overlay icon:

List Creation Behavior

This defines a list name that is the title of the custom list. This value will be displayed as a list header. Optionally, an item list containing the name of the item, the URI value for that item, and an image associated with that item can be provided to populate the list initially. This functionality can be supported when the browser is started in the web application mode.

List Update Behavior

A list item value is provided to update a specific list item. The list item value includes a name for the item, a URI value for that item, and an image associated with the item. This functionality can be supported when the browser is started in the web application mode.

Set Overlay Icon

A URI value is specified that points to the icon that will be used as an overlay for the existing task bar icon. This functionality can be supported when the browser is started in the web application mode.

Set Preview Image

A URI that points to an image that should be used as the pictorial representation for the taskbar preview image (or thumbbar preview). The preview is displayed when the user clicks with the left mouse button on the taskbar icon.

Clear Overlay Icon

This removes existing overly icons on the task bar icon. This functionality can be supported when the browser is started in the web application mode.

Web developers can use the following JavaScript functions to define and modify a set of tool bar buttons that are displayed in the task bar preview window of a specific website.

Toolbar Button Installation

A list of button IDs are specified with a tool tip and image URL. The event is passed to the website for processing when the user selects a tool bar button. The website can then disambiguate between button events. This call is performed at least once when the site mode window is opened in order for the buttons to be displayed. This functionality is supported when the browser is started in the web application mode.

Update Image

This identifies the state and visibility of the button ID that is specified. The states can be enabled or disabled. In at least some embodiments, by default, the buttons are enabled. The view can be either show or hide. By default, defined buttons are visible. This functionality is supported when the browser is started in web application mode.

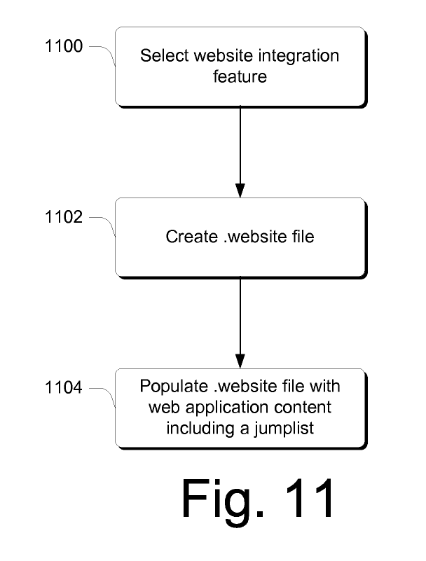

FIG. 11 is a flow diagram that describes steps in an installation method in accordance with one or more embodiments. The method can be performed by any suitable hardware, software, firmware, or combination thereof. In at least some embodiments, aspects of the method are performed by software executing on a client device.

Step 1100 selects a website integration feature. The step can be performed in any suitable way. Typically, the step is performed when a user selects an instrumentality or otherwise takes an action to initiate a web application installation process. For example, a user might select a link that enables him to integrate the web application. Specific examples of how this can be done are provided below.

Step 1102 creates, on the client device, a web application file—here designated “.website” file. This file, as initially created, can constitute an artifact or shell that can subsequently be populated with content and information received from or on behalf of the website. Step 1104 populates the web application file with web application content including, in this example, a jumplist. This step can be performed in any suitable way. For example, this step can be performed through the use of a JavaScript API an example of which is described above. Alternately or additionally, aspects of this step can be performed through the use of markup, such as HTML.

Having created and populated the web application file on the client, the web application can now be launched at any suitable time.

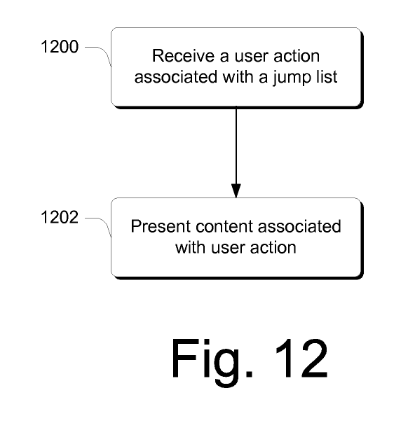

FIG. 12 is a flow diagram that describes steps of a method in accordance with one or more embodiments. The steps can be executed in connection with any suitable hardware, software, firmware, or combination thereof. In at least some embodiments, the method can be performed by software executing on a client in association with software executing on a server.

Step 1200 receives a user action associated with a jumplist. Any suitable user action can be received, examples of which are provided above. For example, in at least some embodiments, the user action can be received with respect to a specifically displayed jumplist or a jumplist that is not displayed. Alternately or additionally, the user action can be received with respect to a displayed icon that is associated with a web application. The icon can be displayed, for example, in a desktop task bar or any other suitable location. Examples of such actions are provided above.

Step 1202 presents content associated with the user action. For example, content presented may comprise the jumplist itself. The jumplist can be presented responsive to any suitable type of user action, examples of which are provided above. The content presented may also comprise content other than the jumplist itself. For example, a custom preview window can be presented responsive to a user action such as, for example, left clicking on a task bar icon. For example, a user might select to create or compose a new email message.

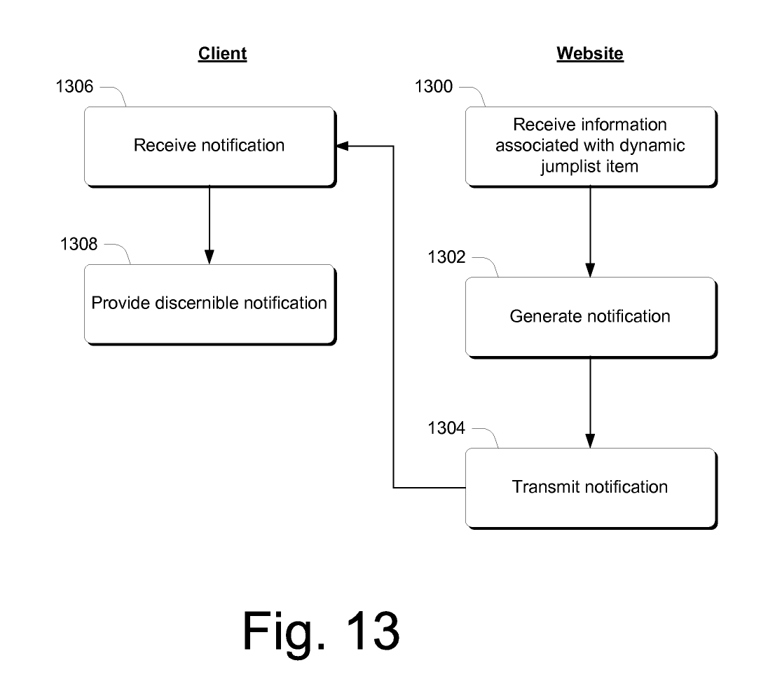

FIG. 13 is a flow diagram that describes steps in a method in accordance with one or more embodiments. The method can be performed by any suitable hardware, software, firmware, or combination thereof. In at least some embodiments, aspects of the method are performed by software executing on a client, and software executing at a server supporting a website. Accordingly, one column of the diagram is designated “Client” to designate those steps performed by or at the client, and one column is designated “Website” to designate those steps performed by or on behalf of the website.

Step 1300 receives information associated with a dynamic jumplist item. Any suitable jumplist item can serve as the basis upon which information is received, examples of which are provided above. Step 1302 generates a notification and step 1304 transmits the notification to a client device executing a web application.

Step 1306 receives the notification and step 1308 provides a discernible notification for the user. Any suitable type of discernible notification can be provided. For example, in at least some embodiments the discernible notification can be a visually-discernible notification such as an overlay icon or a flashing web application icon. Alternately or additionally, the discernible notification can comprise an audibly-discernible notification such as a bell or buzzer.

Having considered various embodiments associated with jumplist integration, consider now a discussion of how websites can become “pinned” to a desktop feature, such as a task bar, in accordance with one or more embodiments.

Taskbar Pinning

There are various ways in which a web application can become integrated with a client desktop or task bar. In at least some embodiments, a web application can be integrated with the desktop through a drag and drop operation. Alternately or additionally, web applications can be integrated via a web browser's menu selections. Alternately or additionally, a web application can be integrated by an associated website itself. Each of these embodiments is discussed under its own heading below.

Integration through Drag and Drop Operations

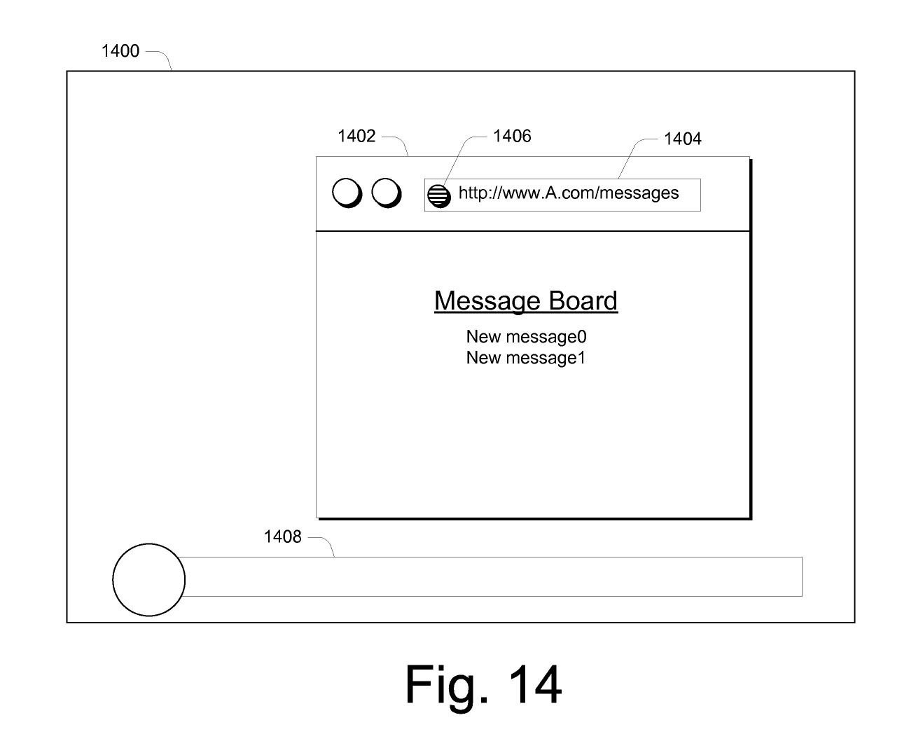

In one or more embodiments, a web application can be integrated with the desktop or task bar through a drag and drop operation. As an example, consider FIG. 14. There, a client desktop is shown generally at 1400. A web browser window 1402 includes an address bar 1404 with a web site URL displayed therein. In association with the URL, an icon, termed a “favicon” 1406, is shown. In addition, desktop 1400 includes a task bar 1408.

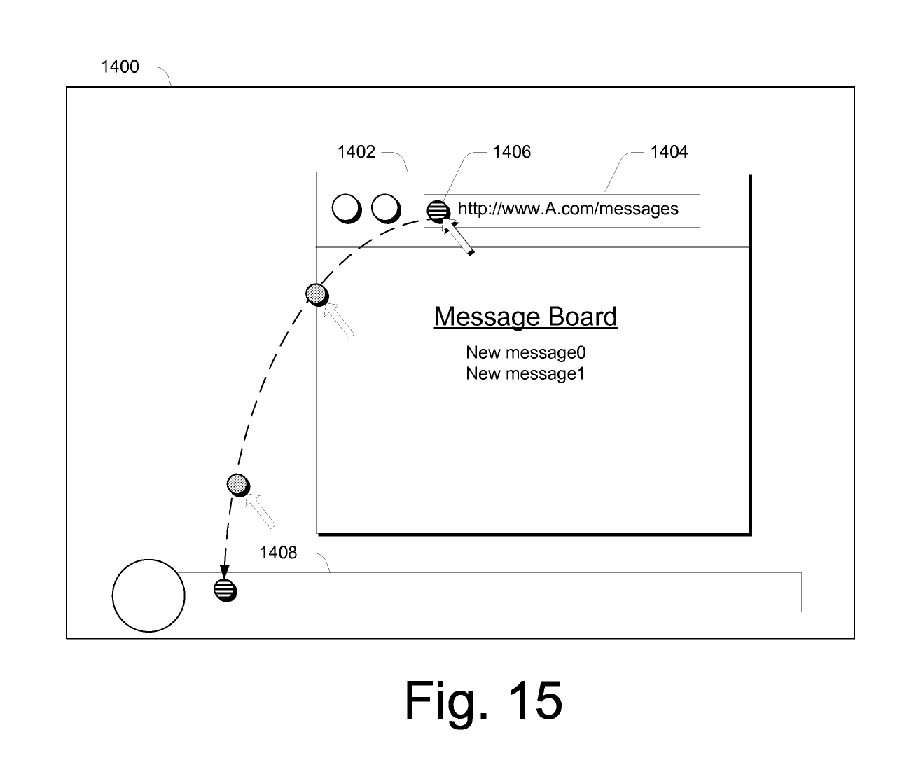

FIG. 15 diagrammatically illustrates a drag and a drop operation in accordance with one or more embodiments. In this example, a cursor has been placed over favicon 1406. By left clicking on the favicon and dragging it along to task bar 1408, the associated web application—in this case a message board application—can be pinned to the desktop's task bar 1408. The drag and drop operation starts the integration process of integrating the web application as described above, thus pinning it to the task bar.

In one or more implementations, if the webpage associated with the web application has a tab opened in the browser, after the favicon is dropped on the task bar, the associated tab can disappear from the browser's window. Alternately or additionally, the tab might not be removed but instead the content of the tab might be replaced with a “New Tab” page. In instances in which a single tab is open in a browser window, the browser window will disappear after the favicon is pinned to the task bar. At this point, the tab that contained in the original site can be removed before the browser closes but after the web application is pinned. In addition, in at least some embodiments, when the drag operation enters the task bar, a tool tip in the form of “Pin to Taskbar” can be presented to inform the user of the pinning functionality.

Further, the state of the website or web application that was pinned to the task bar can be migrated to a newly-displayed window when the web application is instantiated for the first time. This will allow the user to not have to re-enter credentials to the site in order to be able to use the application.

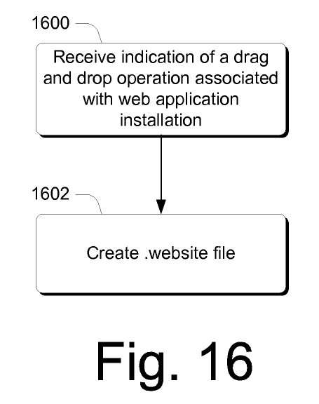

FIG. 16 is a flow diagram that describes steps in an installation method in accordance with one or more embodiments. The method can be performed by any suitable hardware, software, firmware, or combination thereof. In at least some embodiments, aspects of the method are performed by software executing on a client

Step 1600 receives an indication of a drag and drop operation associated with web application installation. The step can be performed in any suitable way. In the embodiment described just above, the step is performed when a user drags and drops an icon such as a favicon, associated with a website, to indicate to the website a desire to integrate an associated web application with their desktop. For example, a user might drag and drop the favicon to the task bar, quick launch area or some other location on the desktop, such as the desktop canvass. Step 1602 creates a web application file responsive to the drag and drop operation. In the illustrated and described embodiment, the web application file that is initially created is an artifact or shell that does not yet contain information from the associated web site such as jumplist tasks, start URLs, favicons or other properties such as static jumplist tasks, an alternate start URL, alternate favicon and the like. These can be added later through new markup and/or JavaScript APIs as described above. It is to be appreciated and understood that techniques other than those that employ a JavaScript API can be utilized without departing from the spirit and scope of the claimed subject matter.

Integration through Browser Menu Selections

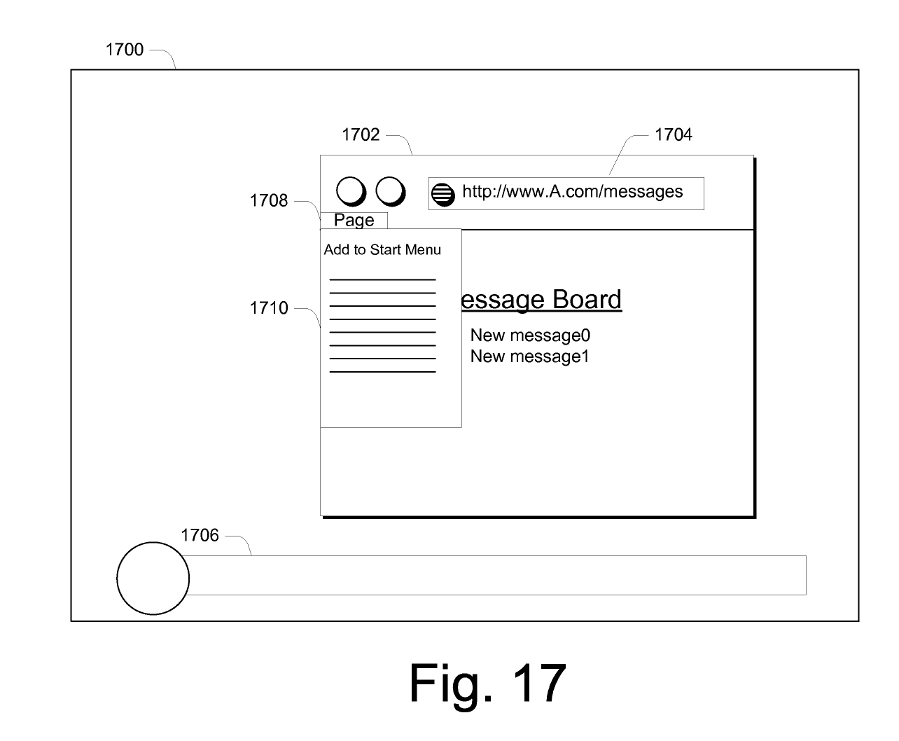

In one or more embodiments, web applications can be integrated via a web browser's menu selections. As an example, consider FIG. 17. There, a client desktop is shown generally at 1700. A web browser window 1702 includes an address bar 1704 with a URL displayed. In addition, desktop 1700 includes a task bar 1706. A browser menu item 1708 in the form of a page menu is shown. By dropping down the page menu to expose menu selections 1710, a menu item or selection “Add to Start Menu” is displayed. By selecting this option, a website or web application can be added to the desktop's start menu and the installation process can be initiated as described above. Alternately or additionally, an “Add to Task Bar” menu item or selection can be displayed to enable initiation of the installation process.

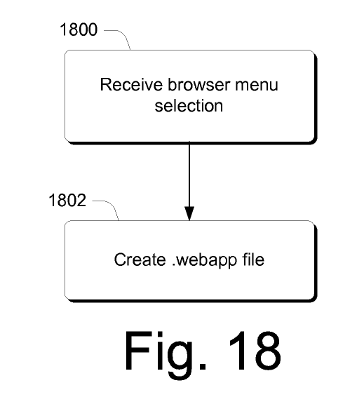

FIG. 18 is a flow diagram that describes steps in an installation method in accordance with one or more embodiments. The method can be performed by any suitable hardware, software, firmware, or combination thereof. In at least some embodiments, aspects of the method are performed by software executing on a client.

Step 1800 receives a browser menu selection. The step can be performed in any suitable way. In the embodiment described just above, this step is performed when a user navigates to a particular website, drops down a browser menu to expose menu selections, and then takes an action by selecting a menu item associated with initiating installation of a web application associated with the website.

Step 1802 creates a web application file responsive to receiving the browser menu selection. In the illustrated and described embodiment, the web application file that is initially created is an artifact or shell that does not yet contain information from the associated web site such as jumplist tasks, start URLs, favicons and the like. These can be added later through new markup and/or JavaScript APIs as described above. It is to be appreciated and understood that techniques other than those that employ a JavaScript API can be utilized without departing from the spirit and scope of the claimed subject matter.

Integration through Associated Website

In one or more embodiments, integration of a web application with a desktop can occur from a webpage. In these embodiments, a particular website can opt into integration activities by using code, such as JavaScript, to integrate the web application into the desktop. This allows the website to be in control of integration initiation instrumentalities.

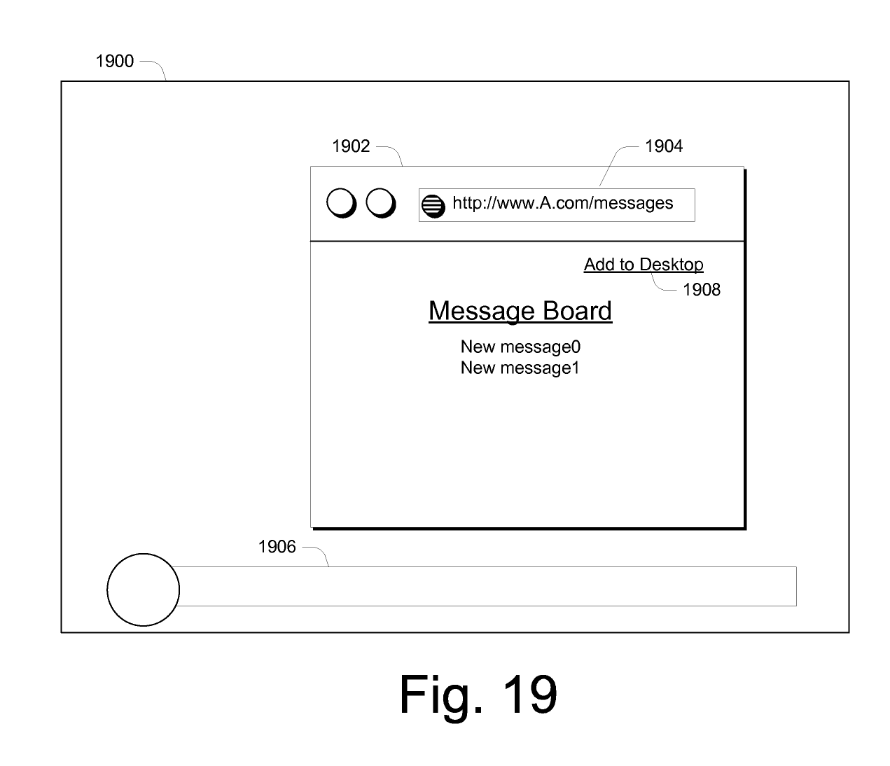

As an example, consider FIG. 19. There, a client desktop is shown generally at 1900. A web browser window 1902 includes an address bar 1904 with a URL displayed therein. In addition, desktop 1900 includes a task bar 1906. Further, a webpage displayed within browser window 1902 includes a link 1908 entitled “Add to Desktop”. By clicking on this link, a user can initiate a web application installation process as described above.

In at least some embodiments, after link selection takes place, a modal confirmation dialog can be presented that explains the user action that the user is taking and where to access their newly-created shortcut. This confirmation dialog can present, to the user, the source URL of the page that is being presented. The URL that is displayed can contain the full path of the website. This can allow the user to verify that the website they wish to install is being served from the correct site. This can mitigate situations associated with malicious subdirectories.

In various implementations, the URL of the website that is to be integrated with the desktop is checked to confirm that it is on the same domain as the webpage that contains it. If not, an error can be displayed and the operation can fail. After the user confirms operation, the dialog can be removed and the web application window can be displayed with the correct URL.

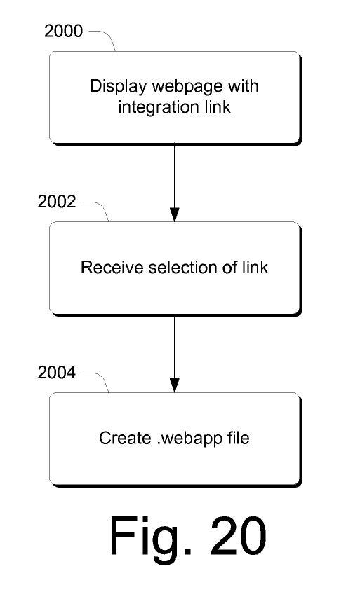

FIG. 20 is a flow diagram that describes steps in an installation method in accordance with one or more embodiments. The method can be performed by any suitable hardware, software, firmware, or combination thereof. In at least some embodiments, aspects of the method are performed by software executing on a client.

Step 2000 displays a webpage with an integration link. The step can be performed in any suitable way, an example of which is provided above. Step 2002 receives a selection of the integration link. Step 2004 creates a web application file responsive to receiving the link selection. In the illustrated and described embodiment, the web application file that is initially created is an artifact or shell that does not yet contain information from the associated web site such as jumplist tasks, start URLs, favicons and the like. These can be added later through new markup and/or JavaScript APIs as described above. It is to be appreciated and understood that techniques other than those that employ a JavaScript API can be utilized without departing from the spirit and scope of the claimed subject matter.

Having considered the various embodiments described above, consider now embodiments in which developers and websites can define how content is to be surfaced on a client device, including content that is accessed from a jumplist task or item. As noted above, content can be surfaced through a variety of content conveyances. For example, content can be surfaced using a tab, pop-up window, browser window, an in-place navigation, or at different levels, such as within a page, such as within a frame or other element. Further, content can be caused to be surfaced using different surfacing mechanisms such as those that employ declarative approaches such as markup like HTML markup and/or script-based approaches, such as through the use of Javascript.

It is to be appreciated and understood that the embodiments described just below can be employed in conjunction with any and/or all of the embodiments described above.

Using Metatags to Define How Content is to be Surfaced

In one or more embodiments, metatags can be utilized to define how content is to be surfaced on a client device. The metatags can be included as part of the HTML that comprises a webpage associated with a start URL or some other webpage associated with a particular website. The metatags can be utilized to define the type of experience that will be surfaced in a jump list. The metatags are used to describe additional attributes, such as window parameters and other associated parameters that define the type of visual conveyance and/or its dimensions that is to be utilized to convey content to user.

As examples of particular metatags, in accordance with one or more embodiments, consider the following.

To open up a new tab associated with a jump list selection, the following metatag can be utilized:

<META name=″msapplication-task″ content=″name=tab;window-
type=tab;action-uri=http://ie-snap/scratchtests/jposey/html/tab.html;icon-
uri=″ />

This metatag enables the web application mode browser to open up a corresponding tab associated with a received user action. The web application mode browser does this by conveying information included in the metatag to an appropriate “open window” call that it can make, for example, on the operating system or some other system component. For example, a user may select a static jumplist task. This metatag format would then tell the web application mode browser to open a tab associated with the jumplist selection. Notice that the window-type contains the type of window in which the site information will be displayed.

To open up a full browser window associated with a jump list selection, the following metatag can be utilized:

<META name=″msapplication-task″ content=″name=window;window-
type=window;action-uri=http://ie-snap/scratchtests/jposey/html/window.
html;icon-uri=″ />

This metatag enables the web application mode browser to open up a corresponding full browser associated with a received user action. The web application mode browser does this by conveying information included in the metatag to an appropriate “open window” call that it can make, for example, on the operating system or some other system component. For example, a user may select a jumplist task. This metatag format would then tell the web application mode browser to open a full browser window associated with the jumplist selection. Notice that the window-type contains the type of window in which the site information will be displayed.

To navigate in place and replace content being rendered in a current window with new content, the following metatag can be utilized:

<META name=″msapplication-task″ content=″name=self1;window-
type=self;action-uri=http://ie-snap/scratchtests/jposey/html/self1.html;
icon-uri=″ />

This metatag enables the web application mode browser to conduct an in place navigation associated with a received user action. The web application mode browser does this by conveying information included in the metatag to an appropriate “open window” call that it can make, for example, on the operating system or some other system component. For example, a user may select a jumplist task associated with opening up a new radio station in their web application. This metatag format would then tell the web application mode browser to conduct an in place navigation associated with the jumplist selection. Notice that the window-type contains the type of window in which the site information will be displayed.

To open up a pop-up window, the following metatag can be utilized:

<META name=″msapplication-task″ content=″name=No Scrollbars;
Window-type=window;width=600;height=300;scrollbars=no;action-
uri=http://ie-snap/scratchtests/phle/html/NoScrollbars.html;icon-uri=″ />

This metatag enables the web application mode browser to open up a pop-up window associated with a received user action. The web application mode browser does this by conveying information included in the metatag to an appropriate “open window” call that it can make, for example, on the operating system or some other system component. For example, a user may select a jumplist task associated with opening up a new email message. This metatag format would then tell the web application mode browser to conduct open up a new email message interface associated with the jumplist selection. Notice that the window-type contains the type of window in which the site information will be displayed. Also, in this example, the metatag includes other parameters such as the dimensions of the pop-up window to be opened.

In at least some embodiments, developers can specify that a starting window that is launched directly from the taskbar, after a site is pinned, can be opened in a default browser window or in a customized pop-up window. Such can be enabled using the metatag shown just below:

<meta name=″msapplication-window″
content=″width=800;height=600;location=no;toolbar=no;resizable=no;
scrollbars=no;menubar=no;″/>

The above approach can be used for both jumplist tasks that are generally static in nature, as well as jumplist items which are more dynamic in nature.

The information included in the various metatags can be stored in any suitable location. For example, in at least some embodiments, the information can be stored in the .website file when a site is pinned as described above. Alternately or additionally, the information can be stored in one or more caches or stores associated with the client device when, for example, the site is pinned as described above.

For example, in at least some embodiments, this information can be stored in a history cache store associated with the Web browser. Alternately or additionally, the information can be stored in an internal store associated with the web application mode browser. Storing the information in a store can enable a web application to be started with the appropriate configuration information when it is not started from the Start URL, as by being launched directly from a jump list. For example, a user may start a web application from a jumplist item selection. In this case, the information can be retrieved from the internal cache or store and used to ensure that the proper defined conveyance is used to surface content for the user.

Using Script to Define How Content is to be Surfaced

In one or more embodiments, in addition to, or alternatively from the above-described metatag approach, script can be utilized to define how content is to be surfaced. Any suitable script or code-based approach can be utilized without departing from the spirit scope of the claimed subject matter. In at least some embodiments, JavaScript can be utilized to define how content is to be surfaced on a client device. JavaScript APIs can be called by a website to provide information that enables the web application mode browser to open up a particular window within which to present content for user. The use of JavaScript APIs is particularly useful in dynamic scenarios such as, for example, those associated with jumplist items.

As but one example of how JavaScript can be utilized, consider the following.

To open up a new tab associated with a jump list selection, the following JavaScript API can be utilized:

window.external.msSiteModeAddJumpListItem(′tab′, ′http://ie-
snap/scratchtests/jposey/html2/tab.html′, ′http://ie-
snap/scratchtests/jposey/icons/SheepPorcelaine.ico′, ′tab′)

This JavaScript enables the web application mode browser to open up a corresponding tab associated with a received user action. The web application mode browser does this by conveying information included in the JavaScript call to an appropriate “open window” call that it can make, for example, on the operating system or some other system component. Notice that the last parameter takes in the type of window in which the site information will be displayed.

To open up a full browser window associated with a jump list selection, the following JavaScript API can be utilized:

window.external.msSiteModeAddJumpListItem(′window′, ′http://ie-
snap/scratchtests/jposey/html2/window.html′, ′http://ie-
snap/scratchtests/jposey/icons/SheepPorcelaine.ico′, ′window′)

This JavaScript enables the web application mode browser to open up a corresponding full browser window associated with a received user action. The web application mode browser does this by conveying information included in the JavaScript call to an appropriate “open window” call that it can make, for example, on the operating system or some other system component. Notice that the last parameter takes in the type of window in which the site information will be displayed.

To navigate in place and replace content being rendered in a current window with new content, the following JavaScript can be utilized:

window.external.msSiteModeAddJumpListItem(′self1′, ′http://ie-
snap/scratchtests/jposey/html2/self1.html′, ′http://ie-
snap/scratchtests/jposey/icons/PandaPorcelaine.ico′, ′self′)

This JavaScript enables the web application mode browser to conduct an in place navigation associated with a received user action. The web application mode browser does this by conveying information included in the JavaScript call to an appropriate “open window” call that it can make, for example, on the operating system or some other system component. Notice that the last parameter takes in the type of window in which the site information will be displayed.

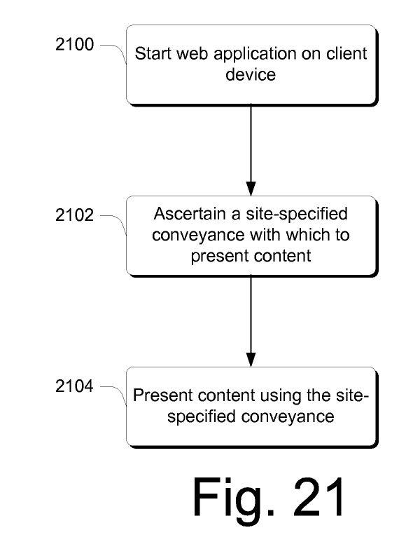

FIG. 21 is a flow diagram that describes steps in a method in accordance with one or more embodiments. The method can be performed by any suitable hardware, software, firmware, or combination thereof. In at least some embodiments, aspects of the method are performed by software executing on a client, such as a suitably configured web application mode browser.

Step 2100 starts a web application on a client device. Examples of how this can be done are provided above. In one or more embodiments, the web application is configured on a client device as described above. For example, the web application can be pinned on the client device on, for example, the task bar, start menu or desktop. Step 2102 ascertains a site-specified conveyance with which to present content on the associated client device. The type of conveyance can be specified in any suitable way. For example, in at least some embodiments, the site-specified conveyance can be specified in a declarative fashion such as, by way of example and not limitation, through the use of markup such as HTML. Alternately or additionally, the site-specified conveyance can be specified to the use of script such as JavaScript. Step 2104 presents content using the site-specified conveyance.

Having considered various web application integration techniques, consider now an example system that can be utilized to implement one or more of the above-described embodiments.

Example System

FIG. 22 illustrates an example computing device 2200 that can be used to implement the various embodiments described above. Computing device 2200 can be, for example, computing device 102 of FIG. 1 or any other suitable computing device.

Computing device 2200 includes one or more processors or processing units 2202, one or more memory and/or storage components 2204, one or more input/output (I/O) devices 2206, and a bus 2208 that allows the various components and devices to communicate with one another. Bus 2208 represents one or more of any of several types of bus structures, including a memory bus or memory controller, a peripheral bus, an accelerated graphics port, and a processor or local bus using any of a variety of bus architectures. Bus 2208 can include wired and/or wireless buses.

Memory/storage component 2204 represents one or more computer storage media. Component 2204 can include volatile media (such as random access memory (RAM)) and/or nonvolatile media (such as read only memory (ROM), Flash memory, optical disks, magnetic disks, and so forth). Component 2204 can include fixed media (e.g., RAM, ROM, a fixed hard drive, etc.) as well as removable media (e.g., a Flash memory drive, a removable hard drive, an optical disk, and so forth).

One or more input/output devices 2206 allow a user to enter commands and information to computing device 2200, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a mechanism to allow end users to install web applications and websites onto their desktop. In accordance with one or more embodiments, client-side code can be utilized to allow developers associated with a website to define boundaries associated with user interaction, and have those boundaries enforced by a run-time engine. In at least some embodiments, developers can provide, through JavaScript code, various configurations for the creation of a start menu shortcut, navigation, and so-called jumplist integration, as well as a variety of other functionality.

Various embodiments enable a site developer to define how content is to be surfaced on a client device, including content that is accessed from a jumplist task or item. Content can be surfaced through a variety of content conveyances. For example, content can be surfaced using a tab, pop-up window, browser window, an in-place navigation, or at different levels, such as within a page, such as within a frame or other element. Further, content can be caused to be surfaced using different surfacing mechanisms such as those that employ declarative approaches such as markup like HTML markup and/or script-based approaches, such as through the use of Javascript.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method comprising:
starting a web application on client device, wherein the web application is pinned on the client device;
ascertaining a site-specified conveyance with which to present content on the client device; and
presenting content using the site-specified conveyance.

2. The computer-implemented method of claim 1, wherein the web application is pinned on a task bar associated with the client device.

3. The computer-implemented method of claim 1, wherein the ascertaining is performed by ascertaining the site-specified conveyance in a declarative fashion.

4. The computer-implemented method of claim 1, wherein the ascertaining is performed by ascertaining the site-specified conveyance through markup associated with a webpage provided by the site.

5. The computer-implemented method of claim 1, wherein the ascertaining is performed by ascertaining the site-specified conveyance through one or more metatags associated with a webpage provided by the site.

6. The computer-implemented method of claim 1, wherein the ascertaining is performed by ascertaining the site-specified conveyance through script through which the site can specify the conveyance.

7. The computer-implemented method of claim 1, wherein the ascertaining is performed by ascertaining the site-specified conveyance through JavaScript through which the site can specify the conveyance.

8. The computer-implemented method of claim 1, wherein the site-specified conveyance comprises a pop-up window.

9. The computer-implemented method of claim 1, wherein the site-specified conveyance comprises a tab.

10. The computer-implemented method of claim 1, wherein the site-specified conveyance comprises a browser window.

11. The computer-implemented method of claim 1, wherein the site-specified conveyance comprises an in-place navigation.

12. One or more computer readable storage media comprising computer readable instructions which, when executed, implement:
a web application mode browser configured to:
ascertain, responsive to an interaction with a jumplist, a site-specified conveyance with which to present content on a client device; and
present content within a web application using the site-specified conveyance.

13. The one or more computer readable storage media of claim 12, wherein the interaction comprises an interaction with a jumplist task.

14. The one or more computer readable storage media of claim 12, wherein the interaction comprises an interaction with a jumplist item.

15. The one or more computer readable storage media of claim 12, wherein the interaction comprises an interaction with a dynamic jumplist task or item.

16. The one or more computer readable storage media of claim 12, wherein the ascertaining is performed by ascertaining the site-specified conveyance through markup associated with a webpage provided by the site.

17. The one or more computer readable storage media of claim 12, wherein the ascertaining is performed by ascertaining the site-specified conveyance through one or more metatags associated with a webpage provided by the site.

18. The one or more computer readable storage media of claim 12, wherein the ascertaining is performed by ascertaining the site-specified conveyance through script through which the site can specify the conveyance.

19. The one or more computer readable storage media of claim 12, wherein the ascertaining is performed by ascertaining the site-specified conveyance through JavaScript through which the site can specify the conveyance.

20. The one or more computer readable storage media of claim 12, wherein the site-specified conveyance comprises one or more of a pop-up window, a tab, a browser window, or an in-place navigation.
